(19) United States
(12) Patent Application Publication
(10) Pub. No.: US 2011/0030990 A1
(43) Pub. Date: Feb. 10, 2011

(54) Cable with Insecticide in Plastics Sheath

(75) Inventors: Ian Henry Francis, Murarrie (AU); Ian Fleetwood Hendry, Murarrie (AU)

Correspondence Address: PATENT ADMINISTRATOR;FMC CORPORATION, 1735 MARKET STREET, PHILADELPHIA, PA, 19103, US

(73) Assignee: FMC Australasia pty Ltd., Murarrie ,Queensland (AU)

(21) Appl. No.: 12/160,547

(22) PCT Filed: Jan. 11, 2007
(86) PCT No.: PCT/AU2007/000019

§ 371 Date: Oct. 6, 2008

(30) Foreign Application Priority Data
Jan. 12, 2006 (AU) 2006900134

(51) Int. Cl. H01B 3/30; H01B 3/28

(52) U.S. Cl. 174/110 AR; 174/110 SR

(57) ABSTRACT

A cable (10) for conducting electricity or an electromagnetic signal, the cable (10) comprising: a central portion (12) having at least one core (15) of a conductive material; and a layer (13) comprising a plastics material having at least one insecticide distributed therethrough, wherein the insecticide is substantially retained in the plastics material.

### FIELD OF THE INVENTION

The present invention relates to cables for conducting electricity or an electromagnetic signal.

### BACKGROUND TO THE INVENTION

Cables, including electrical cables containing electrically conductive wire and fibre optic cables may be laid under the ground where they can be attacked by insects, in particular termites. Typically, termites damage the cable by eating through the plastic sheath around the central core of the cable.

To overcome this problem, a number of approaches have been proposed in which an insecticide has been incorporated with the outer plastic layer of the cable, either throughout the plastic or in localised areas. In these approaches, the insecticide is released or leached from the plastic into the surrounding soil. A “buffer zone” around the cable is thus created, in which insects will be killed should they enter this zone. One of the most significant problems with these approaches is that once the insecticide has substantially leached from the plastic, the outer cable layer becomes nothing more than plain plastic which may be readily attacked by termites as discussed above. Thus, the outer plastic layer which leaches an insecticide has an effective lifetime which is limited by the leaching rate of the insecticide. Another problem with the insecticide leaching plastic layer is that the release of such chemicals into the general environment may harm the environment and kill other organisms. Furthermore, the insecticide may be washed from the soil during heavy rain fall, which may result in pollution to run-off as well as the loss of the lethal “buffer zone”. Furthermore, the cable having an insecticide leaching from it has only limited applications because, in order to work, it requires a substrate into which the termiticide can leach and thus form the lethal “buffer zone”.

### SUMMARY OF THE INVENTION

According to a first aspect of the present invention, there is provided a cable for conducting electricity or an electromagnetic signal, the cable comprising:

a central portion having at least one core of a conductive material; and

a layer comprising a plastics material having at least one insecticide distributed therethrough, wherein the insecticide is substantially retained in the plastics material.

Because the insecticide is retained, the insecticide does not substantially leach from the layer. Thus, its activity is expressed throughout the plastics material of the layer.

Preferably, the layer encloses the central portion of the cable.

In use, the plastics material of the layer provides a physical barrier against the penetration of insects and the insecticide provides a chemical barrier against the penetration of insects.

Preferably, the layer is integrally formed with the central portion of the cable.

Preferably, the plastics material of the layer is any synthetic or semi-synthetic compound formed by organic condensational polymerisation.

Preferably, the plastics material of the layer is any one or a combination of polyamide (nylon), polyethylene, ethylene vinyl acetate, polystyrene, polyvinylchloride, synthetic rubber (eg. neoprene), polymethylmethacrylate (acrylic), polypropylene and polyurethane.

Preferably, the plastics material of the layer is high density polyethylene.

Preferably, the at least one insecticide is any compound that exhibits sufficient lethal control and/or repellent effects against insects.

Alternatively, a separate repellent compound in addition to the insecticide is distributed throughout the plastics material of the layer.

Preferably, the repellent compound does not significantly leach from the plastics material.

In use, the repellent compound provides a repellent barrier against the penetration of insects.

Preferably, the at least one insecticide is any one or combination of pyrethrum, synthetic pyrethroids, organo-chlorines, organo-sulfurs, carbamates, organo-phosphates, formamidines, nicotinoids, spinosyns, phenylpyrazoles, pyrroles, pyrazoles, dinitrophenols, pyridazinones, quinazolines, and benzoylureas.

Typically, the insects impeded by the layer will be termites.

Preferably, the at least one insecticide is a termiticide.

Preferably, the termiticide is a synthetic pyrethroid.

Preferably, the termiticide is any one or combination of bifenthrin, permethrin, deltamethrin, lambda-cyhalothrin, cypermethrin, alpha-cypermethrin, zeta-cypermethrin, tetramethrin, and cyfluthrin or any other synthetic pyrethroid.

Preferably, the concentration of insecticide in the plastic is less than 5 weight %.

Preferably, the concentration of insecticide in the plastic is greater than 0.02 weight %.

Preferably, the insecticide is bifenthrin. If the insecticide is bifenthrin, then preferably its concentration in the plastic is 0.02 to 0.2 weight %, more preferably 0.05 to 2 weight %, more preferably, approximately 0.1 weight %.

The plastics material of the layer may also contain a UV stabiliser distributed therethrough.

Preferably, the cable also comprises an additional layer, enclosing the insecticide containing layer.

Preferably the additional layer is a damage protection layer for the insecticide containing layer.

Preferably, the additional layer is manufactured from an abrasion resistant material, such as high density polyethylene or nylon for example.

Preferably, the additional layer is integrally formed with the insecticide containing layer.

The additional layer may also contain a UV stabiliser distributed therethrough.

Preferably, each core of the central portion has a further layer of an insulation material.

The volume of the central portion of the cable located between the layer of insulation material and the layer may or not be filled with a filler material, which may or may not be an insulation material.

It is noted that the cable may comprise other additional layers to those layers described above.

The cable may be an electrical cable or a fibre optic cable for example.

If the cable is an electrical cable, the at least one core comprises a strand or strands of an electrically conductive material such as copper.

If the cable is a fibre optic cable, then the at least one core comprises a plurality of light conductive transparent glass or plastic fibres.

### BRIEF DESCRIPTION OF THE DRAWINGS

A preferred embodiment of the present invention will now be described, by way of example only, with reference to the accompanying drawing, in which:

FIG. 1 is a cross-sectional view of a cable for conducting electricity or an electromagnetic signal according to preferred embodiments of the present invention.

### DETAILED DESCRIPTION OF A PREFERRED EMBODIMENT

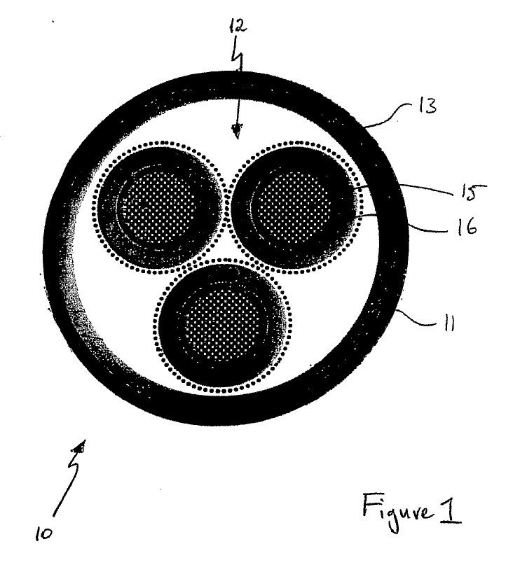

Referring to FIG. 1, a cable 10 for conducting electricity or an electromagnetic signal according to preferred embodiments of the present invention is shown in cross-section. The cable 10 comprises a central portion 12, the central portion having at least one core 15 of a conductive material. In FIG. 1, the central portion 12 of the cable 10 is shown having three cores 15, however, in other embodiments of the invention it may have more or less cores

The cable 10 also comprises a layer 13, which preferably encloses the central portion 12 of the cable 10 as shown in FIG. 1, and which comprises a plastics material having at least one insecticide distributed therethrough, the at least one insecticide being substantially retained in the plastics material.

The layer 13 provides a physical and chemical barrier to impede the penetration of insects because the insecticide does not significantly leach from the plastic, but instead is retained, and its activity is expressed, through the plastic matrix. Because the insecticide's activity is expressed within the plastic it does not require a substrate such as soil to leach into in order for the barrier provided by the layer 13 to work effectively. If termites were to attack the layer 13 of the cable 10, then any contact or ingestion of the insecticide-containing plastic will kill the termites. This is because although the insecticide is tightly bound in the plastic and is not dislodged by water, there is still enough insecticide available to deliver a lethal dose to an insect, which picks insecticide up upon contact with the layer 13. Only a tiny amount of insecticide is required to kill the insect.

The layer 13 may also provide a repellent barrier, ie. will repel insects away from its location if the plastics material of the layer 13 also has a repellent therethrough.

The plastics material of the layer 13 may comprise any synthetic or semi-synthetic compound formed by organic condensational polymerisation and which can be moulded or extruded into objects or films or fibres. Such compounds may include, but are not limited to, polyamide (nylon), polyethylene, ethylene vinyl acetate, polystyrene, polyvinylchloride, synthetic rubber (eg. neoprene), polymethylmethacrylate (acrylic), polypropylene and polyurethane. The plastics material may be formed from a combination of two or more of these compounds. The preferred compound used for the plastics material of the layer 13 is high density polyethylene.

The insecticide(s) which are retained in the plastics material of the layer 13 may be any compound that exhibits control or repellent affects against insect species, particularly termites. These compounds include, but are not limited to, pyrethrum, synthetic pyrethroids, organo-chlorines, organo-sulfurs, carbamates, organo-phosphates, formamidines, nicotinoids, spinosyns, phenylpyrazoles, pyrroles, pyrazoles, dinitrophenols, pyridazinones, quinazolines, and benzoylureas. Preferably, a noted termiticide is used such as bifenthrin, permethrin, deltamethrin, lambda-cyhalothrin, cypermethrin, alpha-cypermethrin, zeta-cypermethrin, tetramethrin, and cyfluthrin. Some of the aforementioned insecticide compounds may also provide a repellent effect, thereby creating the repellent barrier referred to above.

In a preferred embodiment, the insecticide is bifenthrin. Bifenthrin has a non-alpha-cyano molecular structure which renders it a dermal non-sensitiser, ie. does not react substantially with a person's skin. Thus, a person handling the cable 10 is unlikely to experience any reaction on their skin as a result of the bifenthrin in the plastics material. Notably, bifenthrin provides a repellent barrier as well as a chemical barrier to the penetration of insects.

Typically, the concentration of insecticide in the plastics material of the layer 13 is less than 5 weight % and greater than 0.02 weight %. The concentration of insecticide is dependent upon the actual compound used. If the insecticide is bifenthrin, as in the preferred embodiment discussed above, then the concentration of the insecticide (bifenthrin) in the plastics material is 0.02 to 0.2 weight %.

The plastics material of the layer 13 may also contain a UV stabiliser to prevent break down of the plastics material when exposed to sunlight. This is important in maintaining the longevity of the cable 10.

Manufacture of the layer 13 involves mixing the insecticide with prepolymer resins prior to the formation of the plastics material so that a roughly even distribution of the insecticide is achieved throughout the resin. The mixture of insecticide and resins is then formed into a “master” batch of plastic containing insecticide which has a concentration of insecticide which is greater than the end product (ie. greater than 5 weight %). The master batch is later diluted by mixing the molten master batch with molten plastic to achieve the desired concentration of insecticide distributed roughly evenly throughout the melt. The melt is then extruded, moulded or otherwise formed into the layer 13 about the central portion 12 of the cable 10, preferably so that the layer 13 is integrally formed with central portion 12.

As shown in FIG. 1, the cable 10 also comprises an additional layer 11, enclosing the layer 13, which acts as a damage protection layer for the insecticide containing layer 13. This additional layer 11 provides protection to the insecticide containing layer 13 from abrasion and piercing damage, which is of particular concern during installation of the cable 10 when it is susceptible to being rubbed, cut and snagged for example. The additional layer 11 is manufactured from an abrasion resistant material, such as high density polyethylene or nylon for example and is preferably integrally formed with the layer 13 of the cable 10.

Each core 15 has a layer 16 of an insulation material. The insulation layers' 16 primary function is to provide insulation from the other cores. They may also provide thermal insulation for the cores 15.

In the embodiment shown in FIG. 1 the volume of the central portion 12 of the cable 10 located between the insulation layer 16 and the layer 13 may or not be filled with a filler material. The filler material located in this volume may or may not act as further insulation.

The cable 10 may be an electrical cable or fibre optic cable for example. The embodiment shown in FIG. 1 is specifically an electrical cable. In this embodiment the cores 15 of the central portion 12 of the cable 10 each comprise a strand or strands of an electrically conductive material such as copper.

In another embodiment of FIG. 1 where the cable 10 is a fibre optic cable, then the cores 15 generally comprise a plurality of light conducting transparent glass or plastic fibres.

It is to be understood that the cable 10 may comprise other additional layers to those shown in FIG. 1 and described above.

### Example

### Potential for Leaching of Bifenthrin from a Plastic Matrix

A study was conducted to evaluate the potential for bifenthrin distributed through a plastics material to migrate into water.

In the trial a sample of polyethylene containing 0.1% bifenthrin was placed in water, and gently stirred once a week, for a period of six months. The polyethylene and the water were analysed to determine the amount of bifenthrin that had moved into the water at 0, 1 and 6 months.

The analysis of variance showed that there was no significant loss (P>0.05) of bifenthrin from the polyethylene and no significant increase (P>0.05) of bifenthrin in the water after six months compared to the time zero levels.

TABLE 1
One-way alaysis of variance of bifenthrin
concentration in the Water

| Water (μg/mL) | F-test | P value | Significance |
|---|---|---|---|
| Time 0 v 1 month | 0.466 | 0.736 | No significant |
| | | | difference |
| | | | (P > 0.05) |
| Time 0 v 6 | 0.379 | 0.782 | No significant |
| months | | | difference |
| | | | (P > 0.05) |

TABLE 2
One-way analysis of variance of bifenthrin
concentration in the polyethylene

| Plastic (μg/g) | F-test | P value | Significance |
|---|---|---|---|
| Time 0 v 1 month | 20.783 | 0.017 | No significant |
| | | | difference |
| | | | (P0.05) |
| Time 0 v 6 | 2.010 | 0.279 | No significant |
| months | | | difference |
| | | | (P > 0.05) |

In the preceding description of the invention, except where the context requires otherwise due to express language or necessary implication, the word “comprise” or variations such as “comprises” or “comprising” is used in an inclusive sense, ie. to specify the presence of the stated features but not to preclude the presence or addition of further features in various embodiments of the invention.

1. A cable for conducting electricity or an electromagnetic signal, the cable comprising:
a central portion having at least one core of a conductive material; and
a layer comprising a plastics material having at least one insecticide distributed therethrough, wherein the insecticide is substantially retained in the plastics material.

2. A cable as claimed in claim 1, wherein the layer is integrally formed with the central portion of the cable.

3. A cable as claimed in either claim 1 or 2, wherein the layer encloses the central portion of the cable.

4. A cable as claimed in any one of the preceding claims, wherein the plastics material of the layer is any one or a combination of polyamide, polyethylene, ethylene vinyl acetate, polystyrene, polyvinylchloride, synthetic rubber, polymethylmethacrylate, polypropylene and polyurethane.

5. A cable as claimed in any one of the preceding claims, wherein the plastics material of the layer is high density polyethylene.

6. A cable as claimed in any one of the preceding claims, wherein the at least one insecticide is any one or combination of pyrethrum, synthetic pyrethroids, organo-chlorines, organo-sulfurs, carbamates, organo-phosphates, formamidines, nicotinoids, spinosyns, phenylpyrazoles, pyrroles, pyrazoles, dinitrophenols, pyridazinones, quinazolines, and benzoylureas.

7. A cable as claimed in any one of claims 1 to 5, wherein the at least one insecticide is bifenthrin.

8. A cable as claimed in any one of the preceding claims, wherein the concentration of the at least one insecticide is 0.02 to 5 weight %.

9. A cable as claimed in any one of claims 1 to 7, wherein the concentration of the at least one insecticide is 0.05 to 2 weight %.

10. A cable as claimed in any one of the preceding claims, wherein the plastics material of the layer also contains a UV stabiliser distributed therethrough.

11. A cable as claimed in any one of the preceding claims, wherein the cable also comprises an additional layer, enclosing the insecticide containing layer, the additional layer being a damage protection layer for the insecticide containing layer.

12. A cable as claimed in claim 11, wherein the additional layer is manufactured from an abrasion resistant material.

13. A cable as claimed in either claim 11 or 12, wherein the additional layer is integrally formed with the insecticide containing layer.

14. A cable as claimed in any one of claims 11 to 13, wherein the additional layer contains a UV stabiliser distributed therethrough.

15. A cable as claimed in any one of the preceding claims, wherein each core of the central portion has a further layer of an insulation material.

16. A cable as claimed in any one of the preceding claims, wherein the cable is an electrical cable.

17. A cable as claimed in claim 16, wherein the at least one core comprises a strand or strands of an electrically conductive material.

18. A cable as claimed in any one of claims 1 to 15, wherein the cable is a fibre optic cable.

19. A cable as claimed in claim 18, wherein the at least one core comprises a plurality of light conductive transparent glass or plastic fibres.
